(19) United States
(12) Patent Application Publication
(10) Pub. No.: US 2006/0196027 A1
(43) Pub. Date: Sep. 7, 2006

(54) Apparatus for removing and replacing a pin of a track chain

(76) Inventor: George Zacharias, Burns Lake (CA)

Correspondence Address: ANTONY C. EDWARDS, SUITE 200 - 270 HIGHWAY 33 WEST, KELOWNA, BC, V1X 1X7, CA

(21) Appl. No.: 11/365,623

(22) Filed: Mar. 2, 2006

Related U.S. Application Data
(60) Provisional application No. 60/657,438, filed on Mar. 2, 2005.

(51) Int. Cl. B23P 19/04

(52) U.S. Cl. 29/252

(57) ABSTRACT

An apparatus for removing pins from, and installing pins into, the track links of an endless track on a track machine includes a frame having a parallel, spaced apart pair of rigid base members, at least four rigid elongate members mounted therebetween so as to extend between and brace the base members. The elongate members and base members define a rectangular polyhedron space formed of the rectangular prismatic array of members, both base and elongate. A first pair of elongate members lie in a first plane. A second pair of elongate members lie in a second plane orthogonal to the first plane. The first and second planes are parallel to the link pins. The base members lie in a third plane orthogonal to the first and second planes. An actuator drives the link pin which is to be removed or replaced coaxially with the intersection of the first and second planes.

### CROSS REFERENCE TO RELATED APPLICATION

This application claims priority from U.S. Provisional Patent Application No. 60/657,438 filed Mar. 2, 2005 entitled Apparatus for Removing and Replacing a Pin of a Track Chain.

### FIELD OF THE INVENTION

This invention relates to the field of devices for assembling and disassembling a track chain of the type used on tracked work machines such as bulldozes etc. and in particular relates a machine for inserting and removing a pin from a track chain while mounted on to a tracked work machine so as to split apart the track or reassemble the track.

### BACKGROUND OF THE INVENTION

In the prior art, applicant is aware of published United States Patent Application, Publication No. US 2003/0217453, naming applicants Huenefeld et al. published Nov. 27, 2003 and entitled Method and Apparatus for Disassembling a Track Chain. As taught therein, conventionally, track chain assemblies generally include a pair of parallel chains, with each parallel chain being made up of a series of inner and outer track links, further including a series of track pins between and connected to the parallel chains. The track pins and the track links cooperate to form a number of track joints which allow the necessary movement of the track links relative to one another, for example, when the track chain assembly rotates about the sprocket and idlers of the tracked work machine. Huenefeld et al. disclose a disassembly tool which includes a body, a link contact portion and a stationary contact portion, the link contact portion being movable relative to the stationary contact portion so that when the disassembly tool is positioned relative to a track link that is to be removed, the link contact portion may be moved in relation to the stationary contact portion thereby causing the track link to be removed from the track chain assembly. As seen in FIG. 2 from the Huenefeld et al. patent application, presented herein as FIG. 1, the track chain assembly 12 generally includes a plurality of pairs of track joint assemblies 34 pivotally connected together by pairs of outer track links 36. Each track joint assembly 34 includes a pair of inner track links 38 disposed parallel to one another. Each inner track link 38 defines a first aperture 42 and a second aperture 44. The first and second apertures 42, 44 are space a predetermine distance from one another. The predetermined distance defines a track pitch 45. The first and second apertures 42, 44 are configured to receive and provide an interference fit with a track pin 46. The outer track links 36 also define first and second apertures 42, 44 that engage one of the track-pins 46. The track pins 46 and the plurality of inner and outer track links 36, 38 cooperate to form the track assembly 12. Each of the inner and outer track links 36, 38 also defines a pair of bolt holes 48. Each bolt hole 48 receives a bolt (not shown), four bolts attach each track shoe 54 to track chain assembly 12.

In the prior art, applicant is also aware of U.S. Pat. No. 4,063,412 which issued to Bruzek on Dec. 20, 1977 for a Puller Tool. The puller tool of Bruzek is a portable puller tool for track end connectors, the tool having a base with a fluid cylinder for mounting a ram for extension outwardly of the base. An arm extends outwardly of the base to locate an end of the arm at a distance from the base to engage an end connector and a pair of pusher members connected to the ram for engagement with a pair of track pad shafts. Extension of the ram relative to the base causes the base and arm end to move away from the track and pull the track end connector off the track pad shafts.

### SUMMARY OF THE INVENTION

The apparatus for removing pins from, and installing pins into, the track links of an endless track on a track machine, may be characterized as including in one embodiment a frame having a parallel, spaced apart pair of rigid base members, at least four rigid elongate members mounted therebetween so as to extend between and brace the base plates. The elongate members and base plates thereby define a rectangular polyhedron space formed of the rectangular prismatic array of members, both base and elongate. Two of the elongate members, the first pair of elongate members, lie in a first plane containing the link pin to be removed. The remaining two elongate members, the second pair of elongate members, lie in a second plane orthogonal to the first plane. The first and second planes are parallel to the link pins. The base members lie in a third plane orthogonal to the first and second planes.

The elongate members mount to, and between, the base members to form a rectangular prism. The rectangular polyhedron space within the rectangular prism is sufficiently large to encompass the width of the track links. A selectively actuable actuator is mounted to one of the base plates. A ram member mounted to and actuated by the actuator is co-axial with the link pin to be removed which is journalled in the track links. The ram member is at least in part of less diameter than the track pin and sufficiently long so as to displace the track pin from the track links for removal of the track pin from the track links, and to replace the track pin into the track links.

In a first embodiment the first plane contains both the link pin to be removed and the corresponding track links. In the first embodiment the first pair of elongate members are sized to fit into, and be slid through, parallel holes in the corresponding track links, the holes passing laterally through the track links, so that the base members may be mounted to opposite ends of the first pair of elongate members. In that embodiment the second pair of elongate members pass over and under the track links.

### BRIEF DESCRIPTION OF THE DRAWINGS

FIG. 1 is a view of the prior art.

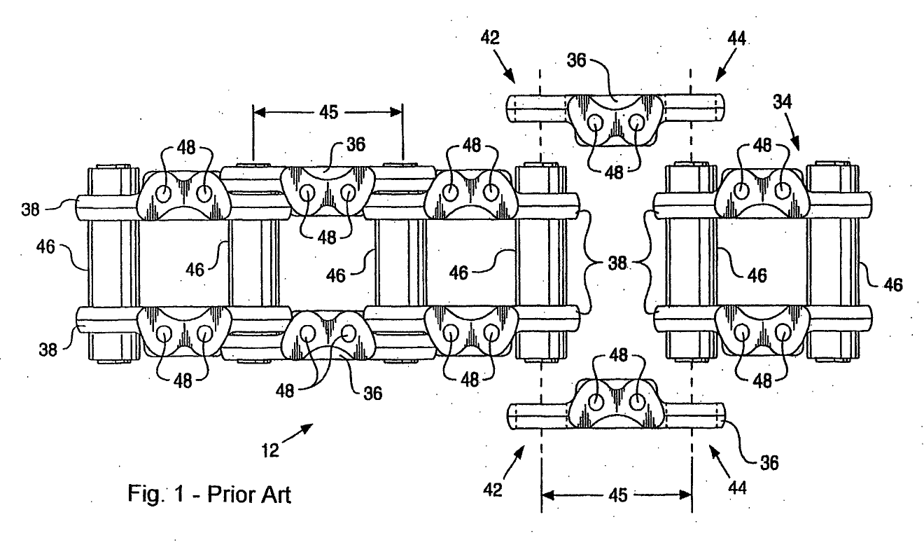

FIG. 2 is a front left perspective view of the present invention installed on a track.

FIG. 3 is a plan view of the device of FIG. 2.

FIG. 4 is a front right perspective view of the device of FIG. 2.

FIG. 5 is a front left perspective view of the device of FIG. 2 better showing the pusher pin.

FIG. 6 is a rear perspective view of the device of FIG. 2.

FIG. 7 is an exploded view of the device of FIG. 2.

FIG. 8 is, in perspective view, an alternative embodiment of the backing plate according to one aspect of the present invention.

### DETAILED DESCRIPTION OF EMBODIMENTS OF THE INVENTION

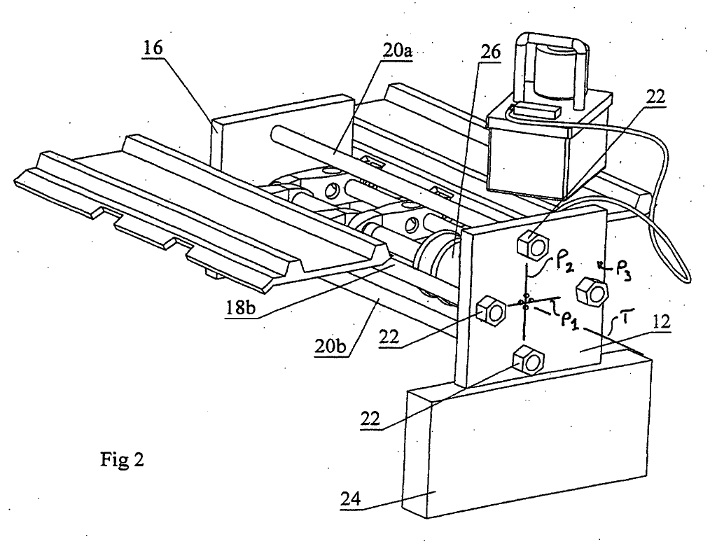

As seen in the accompanying FIGS. 2-7, wherein similar characters of reference denote corresponding parts in each view, the track splitter 10 according to one embodiment of the present invention includes a pair of oppositely disposed parallel rigid base plates supported on opposite sides of a track by four elongate members such as four rigid shafts or rods mounted in equally radially spaced apart parallel array so as to support an actuator such as a hydraulic ram for engaging a track pin of the link bracketed by the four shafts, the link being maintained parallel to the shafts and co-axial to a ram member of the hydraulic ram. Two of the elongate members lie in a first plane P₁ and P₂. the base plates lie in a third plane P₃ orthogonal to planes P₁ and P₂.

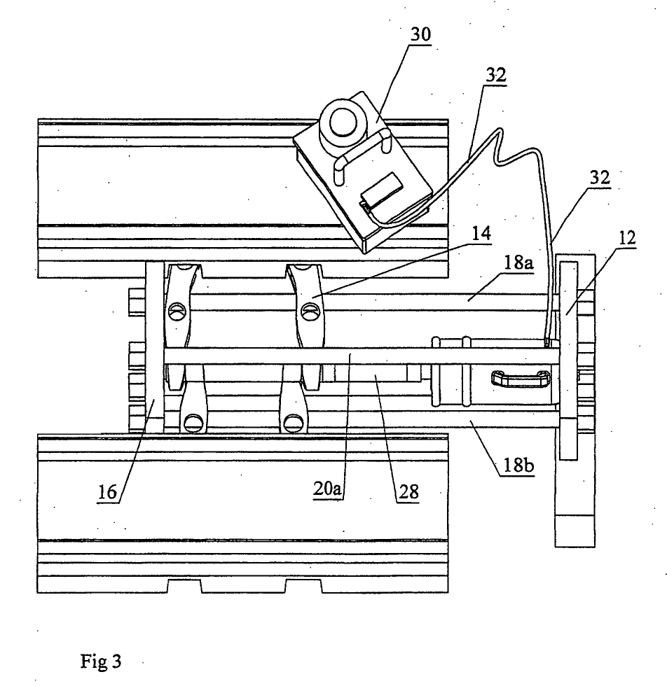

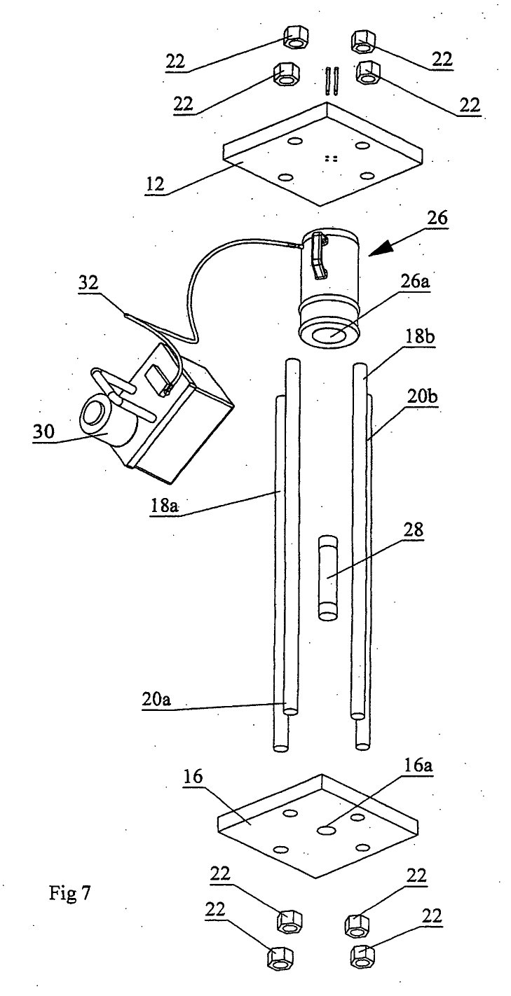

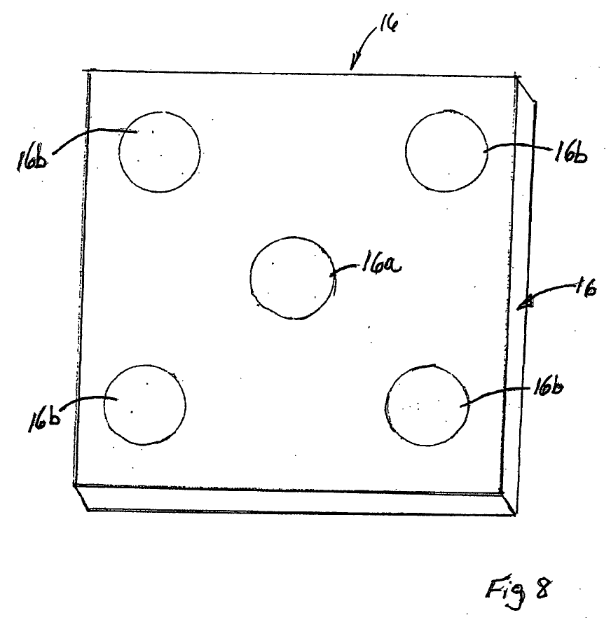

Thus as seen in FIG. 2 ram supporting plate 12 is mounted on one side of track links 14 as better seen in FIG. 3, in oppositely disposed relation to a backing plate 16. Plates 12 and 16 are supported by a first pair of rigid shafts 18a and 18b passing through openings in links 14, shafts 18a and 18b therefore in horizontally spaced apart parallel array, and a second pair of parallel rigid shafts 20a and 20b, shafts 20a and 20b being in vertically spaced apart parallel array. The ends of the four shafts 18a, 18b, 20a and 20b, are journalled through corresponding apertures in plates 12 and 16. The opposite ends of the shafts may be threaded so that the ends of the shafts may be mounted through the apertures in the plates by means of nuts 22 threaded onto the threaded ends of the shafts. Alternatively, plates 12 and 16 may have their radially outermost apertures, that is apertures 16b in the case of plate 16, arranged in the four corners of the plates as seen in FIG. 8, rather than centered along the sides of the plate in the embodiment of FIG. 7. In one embodiment not intended to be limiting, apertures 16b have a diameter of one and one half inches and apertures 16a have a diameter of one and seven eighths inches.

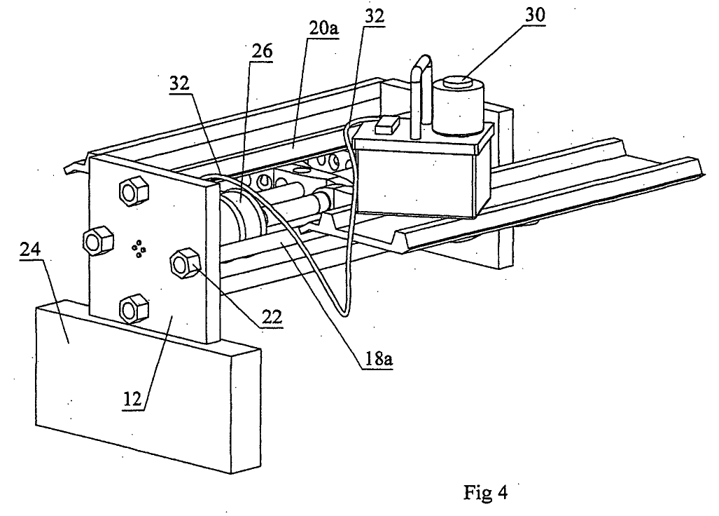

As better seen in FIG. 4, during assembly in the manner described herein below, ram supporting plate 12 may be supported on blocks 24 and so as to assist in keeping the apparatus level during operation.

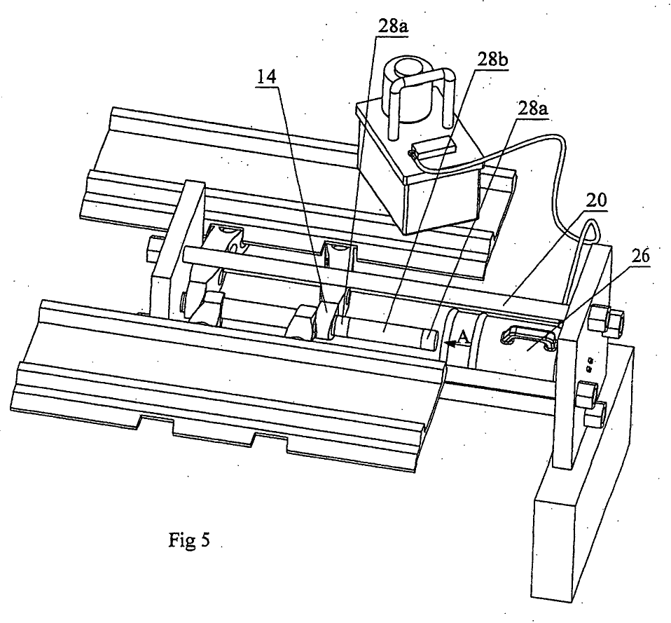

A 50 tonne hydraulic ram 26, such as that marketed as a Power Team Ram, is mounted to ram supporting plate 12 so as to drive a collared pin 28 in direction A as best seen in FIG. 5. A portable hydraulic power unit 30 such as a Power Team™ PE17 Series hydraulic power unit is operatively connected to hydraulic ram 26 by hydraulic fluid lines 32.

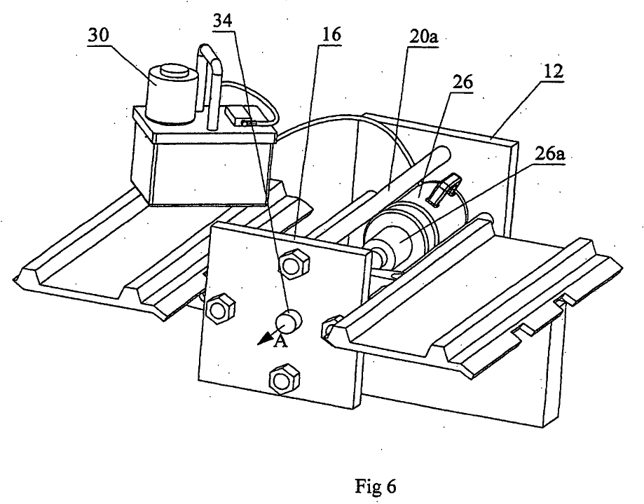

Collar pin 28 has collars 28a at opposite ends thereof which are sized to snugly fit into the pin apertures through links 14. The elongate body portion 28b of collar pin 28 is of lesser diameter than the diameter of the aperture through links 14. Collar pin 28 is used to force the link pin 34 as best seen in FIG. 6. Link pin 34 is pushed from engagement within links 14 through pin removal aperture 16a in plate 16. In use, shafts 18a and 18b are slid through holes in links 14 on either side of link pin 34. Plate 12 is mounted onto the exposed ends of shafts 18a and 18b for example by threading nuts 22 onto the threaded ends. Plate 12 may be placed onto blocks 24 so as to maintain the shafts 18a and 18b level. Plate 16 is mounted to the opposite ends of shafts 18a and 18b, again by threading nuts 22 onto the exposed threaded ends. Pin aperture 16a is aligned with link pin 34 and plate 16 pulled into snug adjacency against the track rail keeping pin aperture 16a and link pin 34 aligned.

Shafts 20a and 20b are installed by sliding them through the corresponding vertically spaced apart apertures in plate 12 so as to extend shafts 20a and 20b parallel to shafts 18a and 18b. The ends of shafts 20a and 20b are journalled through corresponding apertures in plate 16. Shafts 20a and 20b are mounted to plates 12 and 16 at the opposite ends of the shaft for example by mounted nuts 22 onto the threaded ends of the shafts.

Shafts 18a, 18b, 20a and 20b are of equal length, and are sufficiently long so as to allow collar pin 28 and hydraulic ram 26 to be mounted into the spaced defined by the four parallel shafts, with the collared pin and hydraulic ram aligned co-axial with link pin 34. With the ram shaft 26a co-axial with collared pin 28 and link pin 34, hydraulic ram 26 is actuated so as to drive ram shaft 26a in direction A thereby driving collared pin 28 in direction A forcing link pin 34 from links 14. Collar pin 28 is sufficiently long so that for the end of the stroke of ram shaft 26a, link pin 34 has been translated entirely from within links 14 so as to be extracted through aperture 16a on plate 16. With link pin 34 removed, the track may be split apart.

When it is desired to replace link pin 34 so as to reattach the free ends of links 14, pin 32 is placed into the pin receiving apertures in links 14 between the links and hydraulic ram 26 so that upon actuation of hydraulic ram 26, link pin 34 is re-seated in links 14. Collar pin 28 may be required to be inserted between the exposed end of link pin 34 and ram shaft 26a as link pin 34 is inserted into links 14.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for removing link pins from, and installing link pins into, the track links of an endless track on a tracked machine, comprising:
a frame having a parallel, spaced apart pair of rigid base members, at least four rigid elongate members mounted therebetween so as to extend between and brace the base plates, in spaced apart array, said elongate members and said base plates thereby defining a rectangular polyhedron space formed of the rectangular prismatic array of said base members and said elongate members, wherein two of said elongate members, comprising a first pair of elongate members, lie in a first plane containing a link pin to be removed, and wherein a remaining two elongate members comprising a second pair of elongate members, lie in a second plane orthogonal to said first plane, and said base members lie in a third plane orthogonal to said first and second planes,
a selectively actuable actuator and ram member mounted so as to be actuated by said actuator, said ram member co-axial with the link pin to be removed, wherein said ram member is, at least in part, of less diameter than the diameter of the link pin to be removed and sufficiently long so as to displace the link pin to be removed from within the corresponding track.

2. The apparatus of claim 1 wherein said first plane intersects the track links and said first pair of elongate members are sized to fit into, and be slid through, parallel holes in corresponding track links, the parallel holes passing laterally through the corresponding track links, so that said base members are mounted to opposite ends of said first pair of elongate members once said first pair of elongate members are journalled through the parallel holes in the corresponding track links, and wherein said elongate members of said second pair of elongate members pass respectively, over and under, the corresponding track links and are mounted to, and between, said base members to form a rectangular prism defining said rectangular polyhedron space within said rectangular prism, wherein said rectangular polyhedron space is sufficiently large to encompass the width of the corresponding track links.

3. The apparatus of claim 1 wherein said first and second planes intersect along a thrust axis coaxial with said ram.

4. The apparatus of claim 3 wherein said base members are base plates.

5. The apparatus of claim 4 wherein opposite ends of said elongate members mount into apertures in said base plates located substantially midway along opposite edges of said base plates.

6. The apparatus of claim 4 wherein opposite ends of said elongate members mount into apertures in said base plates located substantially in corners of said base plates.

7. The apparatus of claim 5 wherein said base plates are substantially square.

8. The apparatus of claim 6 wherein said base plates are substantially square.

9. The apparatus of claim 5 wherein said actuator is mounted to substantially the center of one of said base plates.

10. The apparatus of claim 6 wherein said actuator is mounted to substantially the center of one of said base plates.

11. The apparatus of claim 1 wherein said elongate members are parallel to each other.

12. The apparatus of claim 11 wherein said elongate members are rods.

13. The apparatus of claim 2 wherein said first and second planes intersect along a thrust axis coaxial with said ram.

14. The apparatus of claim 13 wherein said base members are base plates.

15. The apparatus of claim 14 wherein opposite ends of said elongate members mount into apertures in said base plates located substantially midway along opposite edges of said base plates.

16. The apparatus of claim 15 wherein said base plates are substantially square.

17. The apparatus of claim 15 wherein said actuator is mounted to substantially the center of one of said base plates.

18. The apparatus of claim 2 wherein said elongate members are parallel to each other.

19. The apparatus of claim 18 wherein said elongate members are rods.
